(19) United States
(12) Patent Application Publication
(10) Pub. No.: US 2022/0012523 A1
(43) Pub. Date: Jan. 13, 2022

(54) REPAIR DIAGNOSTIC SYSTEM AND METHOD

(71) Applicant: Tactile Limited, Boumemouth (GB)

(72) Inventors: Rajeev Nayyar, Bournemouth (GB); Michael Duncan Careless, Bournemouth (GB)

(21) Appl. No.: 17/210,796

(22) Filed: Mar. 24, 2021

Related U.S. Application Data
(63) Continuation of application No. 16/096,970, filed on Oct. 26, 2018, now abandoned.

(51) Int. Cl. G06K 9/62; G06K 9/00

(52) U.S. Cl. CPC G06K 9/6201; G06K 9/00624

(57) ABSTRACT

A computer-implemented repair diagnostic method is provided that comprises receiving first image data representing an object with a fault that a user wishes to report, recognising the object by comparing information of the first image data with information in an object datastore comprising information on a plurality of objects, and storing information on the recognised object in a fault diagnostic report.

### BACKGROUND

The present invention relates to a repair diagnostic system and method, particular to a repair diagnostic system and method for enabling faults in objects such as household appliances, furniture and parts of a property to be detected without the need for a user to input a description of the fault.

Repair enquiries or messages are frequently made by tenants or other occupiers to the person or entity that manages the property that that they occupy regarding malfunctions or failures of objects in or forming part of the property such as household appliances.

Typically, if a tenant finds a fault in a home appliance (e.g. a washing machine), a piece of furniture supplied as part of the occupation agreement or a part of their property that they occupy, it is the responsibility of the person or entity who has rented the property to fix the fault. That person or entity may manage the property themselves or through a third party and in each case the person or entity that manages the property is responsible for receiving communications about faults from the tenant. Before the fault can be fixed, the problem needs to be diagnosed and then the appropriate action needs to be taken by the person or entity that manages the property. This action might be the sending of a repair man to fix the fault or it may simply be enough to provide the tenant with instructions to fix the fault themselves.

Managing the process of dealing with faults can be very time consuming and costly, particularly for property managers with a large number of properties to look after.

In addition, it is quite common for tenants or occupiers not to have the same first language as the person who manages the property that they occupy. For example, in a certain location, it might be expected that the property manager speaks a certain language, but many tenants may have poor written skills in that language. As a result, the act of reporting faults is not trivial, especially for non-native language speakers.

### SUMMARY

It is an object of the invention to provide a repair management system and method that has a number of benefits when compared to conventional systems.

According to an aspect of the invention, there is provided a computer-implemented repair diagnostic method (repair reporting method) comprising using a repair management apparatus to: receive first image data representing an object with a fault that a user wishes to report; recognise the object by comparing information of the first image data with information in an object datastore comprising information on a plurality of objects; store information on the recognised object in a fault diagnostic report for managing the repair of recognised object.

The repair diagnostic apparatus may be used to detect an object with a fault that the user of the object wishes to report based on an image of the object received by the repair diagnostic apparatus. As a result, it is not necessary for the user of the object to describe the object, either orally or in writing, to the user of the repair management apparatus in order to report the fault.

Hence, by using such a method, the repair diagnostic apparatus can provide a fault diagnostic report that details a faulty object without text or voice communication about the fault between the user of the object and user of the repair management apparatus.

For example, repair enquiries are frequently made by occupiers to the person or entity that manages the property that they occupy regarding malfunctions or failures of household apparatuses. A property manager may wish to provide a diagnosis of the fault, a cause of the fault, a solution to the fault, or a treatment for the fault. Consequently, a property manager's time may be compromised. Mobile electronic devices having photographic functionality, such as a mobile phone, tablet computer, laptop computer, etc. may send and receive image data via mobile communication or the internet. Furthermore, image comparison engines for comparing image data with other image data to find pairs of image data with a high degree of similarity are known. An image comparison engine for comparing image data may accept an input of target image data. The comparison engine may then search through a plurality of images, identify an image with a high degree of similarity to the target image data and select the image with the highest degree of similarity to the target image data from the plurality of images. Thus, embodiments of the present invention can provide a user with access to information and advice regarding a malfunction or failure of a household apparatus or a part of the property at increased convenience to the property manager and the occupier.

In some embodiments, the object datastore comprises a plurality of items of second image data, each item of second image data being associated with one of the plurality of objects; wherein the comparing information of the first image data with information in the object datastore comprises: performing a reverse image search to compare the first image data with the second image data to recognise the object.

The reverse image search may be performed by an object recognition processor on the second image data stored in the object datastore. In other embodiments, the object datastore need not be part of the repair management apparatus. For example, the object recognition processor may perform a reverse image search using a suitable search engine, for example using the internet.

In some embodiments, after information on the recognised object is stored in the fault diagnostic report, the first image data of the recognised object is added to the object datastore as new second image data. As a result, the object datastore can be populated with information from the users on faults with objects. This enables the “vocabulary” of objects to grow as the system is used.

In some embodiments, the comparing information of the first image data with information in the object datastore comprises: processing the received first image data to isolate feature elements of the object from within the first image data; and comparing the isolated feature elements with information in the object datastore to recognise the object.

In some embodiments, the comparing information of the first image data with information in the object datastore comprises: processing the received first image data to perform optical character recognition to identify text in the first image data; and comparing the identified text with information in the object datastore to recognise the object.

In some embodiments, the recognising the object comprises comparing information of the first image data with information in the object datastore to determining a best match for the object.

In some embodiments, the method further comprises providing: the user with information on the determined best match for the object; and receiving an indication from the user that indicates whether the determined best match corresponds to the object; wherein if the indication from the user that indicates the determined best match does corresponds to the object, the best match is determined as the recognised object.

In some embodiments, if the indication from the user that indicates the determined best match does not correspond to the object, the method further comprises: comparing information of the first image data with information in the object datastore to determining a next best match for the object; and providing the user with information on the determined next best match.

In some embodiments, the first image data is compared with a plurality of candidate images. The plurality of candidate images may be stored in an image store of the repair management system. Alternatively, the plurality of candidate images may be stored in an external database or may be searched for using the internet. An image comparison engine of the repair diagnostic system may compare the target image with the plurality of candidate images. The candidate image with the highest degree of similarity to the first image data may be determined and selected by the image comparison engine (e.g. an object recognition processor).

Based on the fault diagnostic report, information may be sent to the user as a fault response message. The fault response message may include any of a request for input of further image data (e.g. a new photograph of the object), a query about the first image data or a query about a fault, a solution to a fault or a treatment for a fault. The fault response message may instruct, inform or advise the user. If the output is a request for a further image from the user, the steps described herein above may be repeated for the new image data. Alternatively, if the fault response message is a solution to the fault, the user may attempt to solve the fault according to the outputted solution.

In some embodiments, the method further comprises: storing candidate faults associated with the plurality of objects in the object datastore; and providing the user with information on at least one candidate fault associated with the recognised object.

In some embodiments, the method further comprises receiving a user message confirming that a said candidate fault is the fault associated with the object.

Hence, by using such a method, the repair diagnostic apparatus can provide a fault diagnostic report that details a faulty object and the nature of the fault without text or voice communication about the fault between the user of the object and user of the repair diagnostic apparatus.

In some embodiments, the method further comprises diagnosing a most likely candidate fault based on the comparison of the information of the first image data with the information in the object datastore.

In some embodiments, the first image data is received in a fault message comprising information regarding the user including at least one of: location of the user, identity of the user, language spoken by the user, and availability of the user for repair visits. This can further streamline the repair reporting process, and further reduce the need for text/voice communication between the user of the object and user of the repair management apparatus.

In some embodiments, the method further comprises outputting repair information relating to repair of the recognised object to the user of the object. The repair information may comprise information to aid the user repair the recognised object and/or a manual of the object. More generally, the repair information may include any information that is useful to the user with a faulty object. For example, the repair information may include information about how to resolve common faults associated with the object. In some embodiments, the repair information may be provided via augmented reality (e.g. as information overlaid on the user's handheld device). Such augmented reality repair information could be provided via a pre-configured set of advice steps, algorithmically designed (i.e. customised guidance for the repair) or via human real time guidance.

In some embodiments, the first image data is still image data (e.g. a photograph). However, in other embodiments, the first image data may be video data, and the method may comprise may recognise the object by comparing information of the first image data (e.g. information from one or more frames of the video data) with information in the object datastore comprising information on a plurality of objects.

In some embodiments, the method may further comprise using the repair diagnostic apparatus to: output the fault report to a user of the repair management apparatus for managing the repair of recognised object.

In some embodiments, the method may further comprise storing candidate faults associated with the plurality of objects in the object datastore; and diagnosing a most likely candidate fault based on image processing of the first image. For example, the image processing of the first image may determine that there is a particular type of fault (e.g. damp patch on a wall). In such an example, the method may determine that the first image data relates to a wall (e.g. by comparison with information in the object datastore), and then determine the presence of a damp patch based on further image processing of the first image data.

According to an aspect of the invention, there is provided a computer-implemented repair management method (repair reporting method) comprising using a repair management apparatus to: receive first image data representing an object with a fault that a user wishes to report; recognise the object by comparing information of the first image data with information in an object datastore comprising information on a plurality of objects; store information on the recognised object in a fault report, and output the fault report to a user of the repair management apparatus for managing the repair of recognised object.

According to an aspect of the invention, there is provided a computer-implemented repair diagnostic method (repair reporting method) comprising using a repair diagnostic apparatus to: receive first image data representing an object with a fault that a user wishes to report, the user of the object having a first native language; recognise the object by comparing information of the first image data with information in an object datastore comprising information on a plurality of objects; store information on the recognised object in a fault diagnostic report for enabling a user of the repair diagnostic apparatus to manage the repair of recognised object, the user of the repair diagnostic apparatus having a second native language; and send repair information to the user of the object in the first native language.

According to an aspect of the invention, there is provided a repair diagnostic apparatus (repair reporting apparatus) comprising: a communications mechanism arranged to receive first image data, the first image data representing an object with a fault that a user wishes to report; an object recognition processor arranged to recognise the object by comparing information of the first image data with information in an object datastore comprising information on a plurality of objects; and a fault processor arranged to store information on the recognised object in a fault diagnostic report for managing the repair of recognised object

In some embodiments, the repair diagnostic apparatus comprises the object datastore. In other embodiments, the object datastore is stored on an external apparatus, and the object recognition processor is arranged to query the object datastore on the external apparatus.

According to an aspect of the invention, there is provided a repair diagnostic system comprising a repair diagnostic apparatus according to any one of the above aspects; and a user terminal comprising a camera for obtaining the first image data; wherein the communications mechanism is arranged to receive the first image data from the user terminal.

According to an aspect of the invention, there is a computer readable medium carrying computer readable code for controlling a computer to carry out the method of any one of the above aspects.

### BRIEF DESCRIPTION OF THE DRAWINGS

Embodiments of the present invention will now be described, by way of example only, with reference to the accompanying drawings, in which:

FIG. 1 shows a schematic illustration of a repair diagnostic apparatus according to a first embodiment of the invention;

FIG. 2 shows a flow chart of the operation of the first embodiment;

FIG. 3 shows a schematic illustration of a repair diagnostic system according to a second embodiment of the invention;

FIG. 4 shows a schematic illustration of a user terminal according to the second embodiment of the invention; and

FIG. 5 shows a flow chart of the operation of the second embodiment.

### DETAILED DESCRIPTION

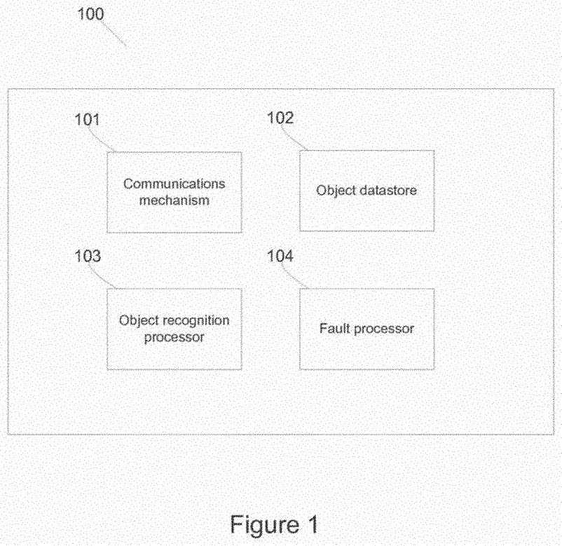

FIG. 1 shows a schematic diagram of repair diagnostic apparatus 100 according to a first embodiment of the invention.

In this embodiment there is a communications mechanism 101, an object datastore 102, an object recognition processor 103, and a fault processor 104.

In this embodiment, the communications mechanism 101 is arranged to receive first image data, the first image data representing an object with a fault that a user wishes to report. The user in this context would typically be the user of the object in question.

For example, the communications mechanism 101 may receive the first image data from the user's device (not shown) such as a smartphone, tablet or PC. However, other embodiments of the invention could be implemented in different ways, and the repair diagnostic apparatus 100 may in some embodiments comprise a suitable image capture device such as a camera (not shown).

The object recognition processor 103 is arranged to perform processing on the information of the first image data in order to recognise the object. In particular, as will be discussed in more detail below, the object recognition processor 103 is arranged to compare information of the first image data with information in the object datastore 102. The object datastore 102 comprises information on a plurality of candidate objects. This information can take a variety of forms. For example, it may include a set of images of candidate objects that are tagged to indicate what these candidate objects are. For example, the images of candidate objects may be stored with suitable metadata to indicate what these objects are.

The metadata may include any information that could be used to identify the object. The meta data could, for example, state that an image of a candidate object is a washing machine, as well as the manufacturer name and model number. The metadata may also indicate the location of candidate objects.

The fault processor 104 is arranged to store information on the recognised object in a fault diagnostic report (not shown). The fault diagnostic report can be used to trigger a repair action by the user of the repair diagnostic apparatus 100.

The repair diagnostic apparatus 100 enables the detection of an object (e.g. a household appliance or a part of a property e.g. a chimney) in a repair management (or repair reporting) process based on an image of the objection. For example, the user of the object may think that there is a fault associated with the object and may wish to report the fault. As an illustrative example, the object may be a household appliance and the user of the object may be a tenant who needs to report the fault to their property manager (user of the repair diagnostic apparatus 100).

The property manager may use the repair diagnostic apparatus 100 to detect the object (e.g. household appliance) with a fault that the occupier wishes to report based on an image of the object received by the repair diagnostic apparatus 100. As a result, it is not necessary for the user of the object (e.g. the occupier) to describe the object or the fault affecting such object, either orally or in writing, to the user of the repair diagnostic apparatus 100.

In some embodiments, the repair diagnostic apparatus 100 may comprise a suitable user interface (e.g. a display) for providing information on the fault diagnostic report to the user of the repair diagnostic apparatus 100. In other embodiments, information on the fault diagnostic report may be sent to an external device.

In this embodiment, the fault diagnostic report provided by the fault processor 104 can be used by the user of the repair diagnostic apparatus 100 (e.g. a property manager) to trigger a repair action. The repair action may take various forms, depending on the nature of the object or the nature of the fault.

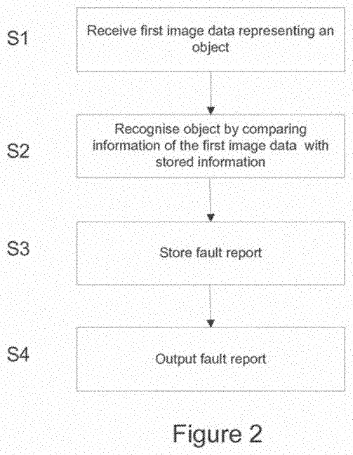

An example operation the repair diagnostic apparatus 100 will be discussed below in relation to FIG. 2.

At step S1, the communications mechanism 101 receives first image data representing an object with a fault that a user wishes to report. For the sake of convenience of description in the following, this object will be referred to as the “faulty object”. For example, a user of the object may obtain a target image (e.g. the first image data) of an objection (e.g. a household appliance or the like) via a camera of the user terminal. In other embodiment, a user terminal may receive a target image of a household appliance or the like from another device having the camera.

Then, at step S2, the object recognition processor 103 recognises the faulty object by comparing information of the first image data (e.g. an image of the object) with information in the object datastore 102 comprising information on a plurality of candidate objects. The candidate objects in this context are in this embodiment may be objects of the same type or sort as the faulty object. For example, in the property manager example mentioned above, it might be expected that faults will occur with household appliances (washing machines, boilers etc.), furniture commonly found in tenants homes and/or parts of a property and that are the responsibility of the property owner acting by themselves as property manager or through a third party property manager to replace/repair if faulty. As a result, in such an example, the object datastore 102 may store information on household appliances, furniture and parts of the interior and exterior of properties and the like.

In this embodiment, the object datastore 102 comprises a plurality of items of second image data, each item of second image data being associated with a candidate object of the same type or sort as the faulty object. Each item of second image data may be an image of a candidate object. In the comparison of step S2, the object recognition processor 103 may compare information of the first image data with information in the object datastore 102 by performing a reverse image search to compare the first image data with the second image data to recognise the object.

The reverse image search may be performed by the object recognition processor 103 on the second image data stored in the object datastore 102.

It will be understood that a reverse image search is general term for a content-based image retrieval query technique that involves providing a sample image to a suitable search engine that it will then base its search upon. It will be appreciated that there are a number of known reverse image search techniques, and any appropriate technique could be used in this context. For example, some commonly used reverse image search algorithms include: scale-invariant feature transform algorithms, maximally stable extremal regions algorithms, and vocabulary tree algorithms.

In other embodiments, the object datastore 102 need not be part of the repair diagnostic apparatus 100. For example, the object recognition processor 103 may perform a reverse image search using a suitable search engine, for example using the internet.

Hence, in some embodiments, the object datastore 102 contains a plurality of previously processed images (e.g. with suitable metadata). In other embodiments, the object datastore 102 may be connected to an external database of images or the internet. In some embodiments, the image object datastore 102 may use an external search engine.

In some embodiments, in the comparison of step S2, the object recognition processor 103 may compare information of the first image data with information in the object datastore 102 by processing the received first image data to isolate feature elements of the object from within the first image data, and then comparing the isolated feature elements with information in the object datastore to recognise the object.

For example, the first image data may be analysed to determine control points, and these control points be compared to object meshes stored in the object datastore 102 to determine the type of object. In some embodiments, the object recognition may be performed in a way analogous to facial recognition, but for other objects (e.g. household appliances).

In other embodiments, other object recognition or computer vision techniques could be used.

Once, the faulty object has been recognised by the above comparison, the repair diagnostic apparatus 100 can identify the object based on the information regarding the object (e.g. metadata) in the object datastore 102.

Hence, by using such a method, the repair diagnostic apparatus 100 can provide a fault diagnostic report that details a faulty object without text or voice communication about the fault between the user of the object and user of the repair diagnostic apparatus.

At step S3, the fault processor 104 stores information on the recognised faulty object in a fault diagnostic report.

At step S4, the fault processor 104 outputs the fault diagnostic report to a user of the repair diagnostic apparatus for managing the repair of recognised object. The fault diagnostic report may be output via the communications mechanism 101.

Hence, the user of the repair diagnostic apparatus 100 can use the fault diagnostic report to manage the repair process for the object. This repair process is driven by the specific fault diagnostic report and may include (as appropriate) instruction of a contractor to resolve, instruction of a contractor to quote to resolve, notification to an appropriate insurer, referral for resolution to a property owner (if different to the property manager) or referral for resolution to an occupier in accordance with the terms on which they occupy the property.

The fault diagnostic report may be output to the user of the repair diagnostic apparatus 100 in a variety of different ways. For example, it may be sent as a message to the user of the repair diagnostic apparatus, or may be displayed on the repair diagnostic apparatus 100 for the user of the repair diagnostic apparatus 100 to see.

In some embodiments, the fault processor 104 may further derive a response to output to the user. The derived response may include, but is not limited to, a request for a further image, a query about the target image or a query about a fault, a solution to a fault or a treatment for a fault.

In some embodiments, the first image data is received in a fault message comprising information regarding the user including at least one of: location of the user, identity of the user, language spoken by the user, and availability of the user for repair visits. This can further streamline the repair diagnostic/management process.

In other embodiments, the fault diagnostic report need not be output directly to a user of the repair diagnostic apparatus. For example, as discussed, in some embodiments, the information may be sent to the user as a fault response message relating to the object and/or fault. Such information may comprise information to aid the user repair the recognised object and/or a manual of the object.

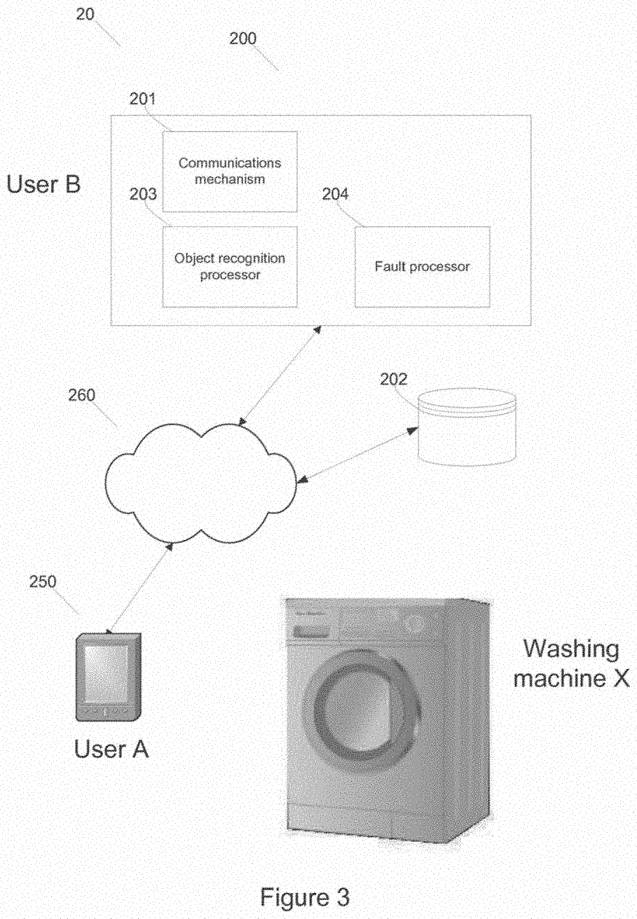

FIG. 3 shows a schematic diagram of repair diagnostic system 20 according to a second embodiment of the invention.

In this embodiment there is a repair diagnostic apparatus 200 that comprises a communications mechanism 201, an object recognition processor 203, and a fault processor 204. The repair diagnostic system 200 is in communication with an external object datastore 202.

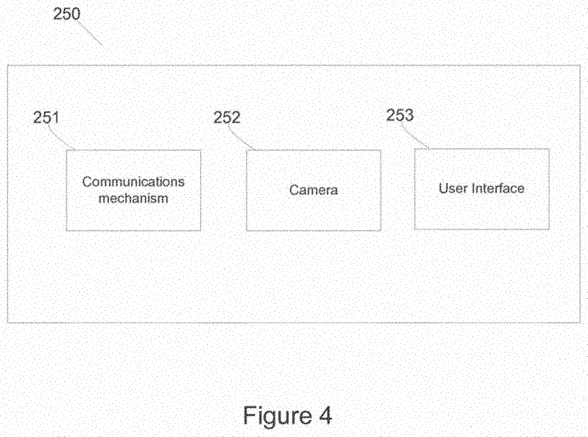

There is also a user terminal 250, shown in more detail in FIG. 4, that comprises a communications mechanism 251, a camera 252, and a user interface 253.

The communications mechanism 251 of the user terminal 250 can communicate with the communications mechanism 201 of the repair diagnostic apparatus 200 via the network 260. The network 260 in this embodiment is the internet, however, embodiments of the invention are not limited to this and any suitable communications technology could be used.

In this embodiment, the external object datastore 202 stores information on a plurality of candidate objects as well as storing candidate faults associated with the plurality of objects. The information on a plurality of candidate objects includes information that can be used to identify objects. For example, it may include a set of images of candidate objects that are tagged to indicate what these candidate objects are. For example, the images of candidate objects may be stored with suitable metadata to indicate what these objects are.

As a result, in this embodiment, the external object datastore 202 stores information on objects that might be candidates to be the faulty object identified by the user as well as information on the likely faults (i.e. the candidate faults) associated with those objects. The communications mechanism 201 can communicate with the external object datastore 202 via the network 260.

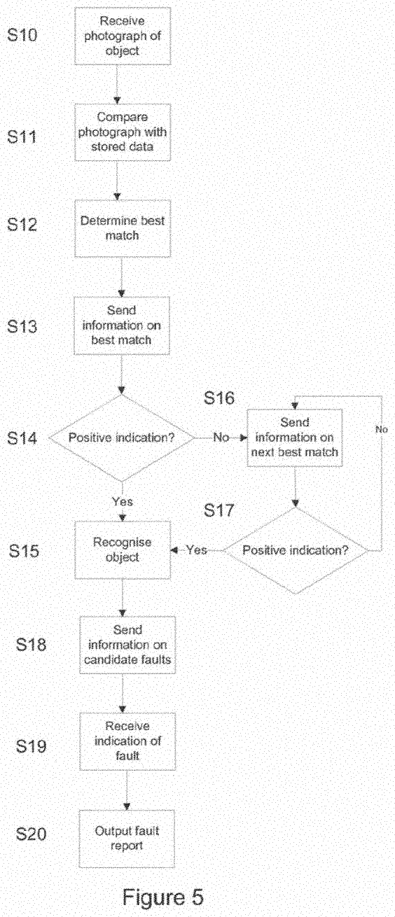

An example operation the repair diagnostic apparatus 200 will be discussed below in relation to FIG. 5. In this example, user A of the user terminal 250 is a tenant and the repair diagnostic apparatus 200 is under the control of property manager B. In this example, the user terminal 250 is a smartphone.

User A has a washing machine X that is at fault. User A wishes to report this fault to the property manager B.

The user A takes a photograph of washing machine X using the camera 252 of the user terminal 250. Then the communications mechanism 251 of the user terminal 250 sends the photograph of washing machine X to the communications mechanism 201 of the repair diagnostic apparatus 200 via network 260. In this embodiment, user A may be running a suitable application on the user terminal 250 (i.e. smartphone) that is provided by property manager B. However, other embodiments of the invention are not limited to this.

In this embodiment, it is assumed that user A and property manager B do not share a common language. As a result, the application running on the user terminal 250 may be in the native tongue of user A, while the output of the repair diagnostic apparatus 200 (e.g. a fault diagnostic report) may be in the native tongue of property manager B. As discussed below, a fault in washing machine X can be reported to the repair diagnostic apparatus 200 without needing without text or voice communication between user A and property manager B.

In this embodiment, the photograph of washing machine X is sent as a fault message by the application on the user terminal 250. The fault message comprises information regarding user A including the location and identity of user A. The location of user A could be provided by a GPS system in the user terminal 250 (not shown), and the identity of user A may be known to the application on the user terminal 250 via a suitable log-in.

At step S10, the communications mechanism 201 of the repair diagnostic apparatus 200 receives the photograph of washing machine X.

At step S11, the object recognition processor 203 compares the photograph of washing machine X with information in the external object datastore 202. In this embodiment, the external object datastore 202 comprises a set of photographs of candidate objects (e.g. household appliances) that users may report as faulty to the property manager B. In this embodiment, the object recognition processor 203 compares the photograph of washing machine X with the photographs of candidate objects by performing a reverse image search. However, it will be appreciated that other object recognition techniques could be used.

At step S12, the object recognition processor 203 determines a best match for the photograph of washing machine X against the photographs of candidate objects in the external object datastore 202. In some embodiments, if there are no candidate objects with a high degree of similarity to the photograph in step S12, the repair diagnostic apparatus 200 may request for further photograph to be taken at the user terminal 250.

At step S13, the repair diagnostic apparatus 200 sends via the communications mechanism 201 information on the determined best match. In this embodiment, this information comprises the photograph of the candidate object that is deemed to be the best match. In other embodiments, this information could take other forms such as a name or description of the candidate object that is deemed to be the best match. Such a name or description could be provided in addition to the photograph of the candidate object that is deemed to be the best match.

Hence, in this example, the photograph of the candidate object that is deemed to be the best match may be expected to be a photograph of a washing machine of the same type as washing machine X.

The user terminal 250 then displays the information on the determined best match (i.e. the photograph of the candidate object that is deemed to be the best match) to the user via the user interface 253 and receives a user indication regarding whether the determined best match corresponds to washing machine X.

Information on this user indication is sent by the user terminal 250 to the repair diagnostic apparatus 200 and received at step S14.

If the indication from the user indicates the determined best match corresponds to the washing machine X (i.e. a positive indication), the best match is determined as the recognised object in step S15. In other words, the candidate object that is deemed to be the best match is determined to be the same as washing machine X.

At step S16, if the indication from the user that indicates the determined best match does not correspond to the object (i.e. not a positive indication), user A is sent information on the determined next best match (i.e. the photograph of the candidate object that is deemed to be the next best match). Hence, in this example, user A may be sent an image of a washing machine that was the next best match.

The user terminal 250 displays the information on the determined next best match (i.e. the photograph of the candidate object that is deemed to be the next best match) to the user via the user interface 253 and receives a user indication regarding whether the determined next best match corresponds to washing machine X. Information on this user indication is sent by the user terminal 250 to the repair diagnostic apparatus 200, and received at step S17.

If the indication from the user indicates the determined best match corresponds to the washing machine X (i.e. a positive indication), the next best match is determined as the recognised object in step S15. If the indication from the user that indicates the determined next best match does not correspond to the object (i.e. not a positive indication), steps S16 and S17 are repeated.

At step S18, the repair diagnostic apparatus 200 sends via the communications mechanism 201 information candidate faults associated with the recognised object (i.e. washing machine X). Hence, in this example, the candidate faults could be a list of potential faults with washing machine X.

For example, the candidate faults could be the washing machine not turning on, the washing machine not draining, or the washing machine leaking. Such identification of specific faults could be driven entirely through the image recognition process, could be tenant/user selectable from an appropriate shortlist or could be identified through OCR of fault codes displaying on the machine.

At step S19, the repair diagnostic apparatus 200 receives via the communications mechanism 201 a user message confirming that a particular candidate fault is the fault associated with washing machine X.

At step S20, the a fault processor 204 stores and outputs a fault diagnostic report that indicates that user A has a particular fault associated with washing machine X. The fault diagnostic report may be output via the communications mechanism 201. Hence, property manager B can use the fault diagnostic report to manage the repair process for washing machine X.

The fault diagnostic report may be output to property manager B in a variety of different ways. For example, it may be sent as a message to property manager B, or may be displayed on the repair diagnostic apparatus 200 on a display or user interface (not shown) for property manager B to see.

In this embodiment, the fault message comprises information regarding user A including the location and identity of user A. Hence, the fault diagnostic report for property manager B in this embodiment can include: the faulty object, the nature of the fault, and the identity and location of user A. This repair process is driven by the specific fault diagnostic report and may include (as appropriate) instruction of a contractor to resolve, instruction of a contractor to quote to resolve, notification to an appropriate insurer, referral for resolution to a property owner (if different to the property manager) or referral for resolution to an occupier in accordance with the terms on which they occupy the property.

Therefore, by using such a method, the repair diagnostic apparatus 200 can provide the property manager B with a fault diagnostic report that details the faulty appliance, the nature of the fault, and the identity and location of user A without intervention from the property manager B, and without text or voice communication between user A and property manager B. For example, the language used on the user interface 253 on the user terminal 250 may be the mother tongue of user A, which may be different to the language spoken by property manager B.

The fault diagnostic report in this embodiment details the faulty object (i.e. washing machine X) and the nature of the fault. In addition, the steps prior to the generation of the fault could be done without knowledge or input from the property manager B. The fault diagnostic report may be in the native tongue of property manager B, which may be different to the native tongue of user A. Hence, a fault in washing machine X can be reported to the repair diagnostic apparatus 200 without needing without text or voice communication between user A and property manager B.

As discussed, in the second embodiment, candidate faults associated with the plurality of objects are stored in the object datastore 202, and the user is provided with information on at least one candidate fault associated with the recognised object. These candidate faults may represent previously noted or known potential faults with certain objects, and the object recognition processor 203 may rank the candidate faults according to how common they are, data previously associated with the property record such as previous fault diagnostic reports relating to the property, data from an inventory of the property and/or the location of the property e.g. an image of a man made structure to hold a volume of water may be more likely to be a swimming pool in Australia and a pond in the United Kingdom.

In some embodiments, the object recognition processor 203 can diagnose a most likely candidate fault based on the comparison of the information of the first image data with the information in the object datastore.

In other words, using the example provided above, the object recognition processor 203 can compare the photograph of washing machine X against the photographs of candidate objects in the external object datastore 202 and determine a likely candidate fault based on this comparison. For example, the photographs of candidate objects in the external object datastore 202 may include multiple photographs of the same type of object (e.g. of the make/model of washing machine X) with different faults. In other words, the external object datastore 202 may include multiple photographs of the same type of object in different fault states.

Using such a method, the comparison of the information of the first image data with the information in the object datastore can lead to a determination that an object in a certain fault state is a best match for the faulty object.

In some embodiments, after information on the recognised object is stored in the fault diagnostic report, the first image data of the recognised object is added to the object datastore as new second image data. As a result, the object datastore 202 can be populated with information from the users on faults with objects. This enables the “vocabulary” of objects to grow as the system is used. This is particularly useful if the object datastore 202 is controlled by the user of the repair diagnostic apparatus. This can enable the user of the repair diagnostic apparatus to build up a library of images that relate to the type of objects that they may need to repair.

Also, in some embodiments, if there are no candidate objects with a high degree of similarity to the photograph in step S12, the repair diagnostic apparatus 200 may store the photograph of the object in the object datastore 202, and provide this to the user of the repair diagnostic apparatus for tagging. Therefore, the accuracy of future object may be improved.

In some embodiments, based on the fault diagnostic report, information may be sent to the user as a fault response message. The fault response message may include any of a request for input of further image data (e.g. a new photograph of the object), a query about the first image data or a query about a fault, a solution to a fault or a treatment for a fault. The fault response message may instruct, inform or advise the user. If the output is a request for a further image from the user, the steps described herein above may be repeated for the second image data. Alternatively, if the fault response message is a solution to the fault, the user may attempt to solve the fault according to the outputted solution.

In some embodiments, the first image data (e.g. a photograph of the object) or a portion of the first image data may undergo an image recognition process such as OCR. In such embodiment, the comparing information of the first image data with information in the object datastore may comprise processing the received first image data to perform optical character recognition to identify text in the first image data; and comparing the identified text with information in the object datastore to recognise the object.

In some embodiments, the repair diagnostic apparatus can output repair information relating to repair of the recognised object to the user of the object. The repair information may comprise information to aid the user repair the recognised object and/or a manual of the object. More generally, the repair information may include any information that is useful to the user with a faulty object. For example, the repair information may include information about how to resolve common faults associated with the object.

In some embodiments, the repair information may be provided via augmented reality (e.g. as information overlaid on the user's handheld device). Such augmented reality repair information could be provided via a pre-configured set of advice steps, algorithmically designed (i.e. customised guidance for the repair) or via human real time guidance.

In embodiments that identify at least one candidate fault with the object, the repair information may include relating to the candidate fault(s). For example, the repair information may include information about how to resolve one or more of the candidate faults.

In some embodiments, the repair information may be output in the language of the user of the object. For example, as discussed, in some embodiments, the first image data is received in a fault message comprising information regarding the language spoken by the user of the object. In such embodiments, the repair information may be output in that language, which may be different to the language spoken by the user of the repair diagnostic apparatus.

In some embodiments, a most likely candidate fault can be diagnosed based on image processing. For example, image processing of a received image of a wall could be used to identify specific types of damp and mould not only by way of checking against a database of images but also by using an algorithm which predicts the likelihood of a patch on a wall being type A vs type B based on factors including colour, texture mapping, pattern and pattern repetition. In a similar way, water in an image (e.g. showing that there is a leak) could be identified by image processing that determines that there are reflections resulting from the water.

In embodiments in which there is a camera, a 2d of 3d camera may be used. 3d cameras allow depth scanning and used in conjunction with 2d scanning offer the ability to create a more accurately representation of the object.

In some embodiments, a request for a further photograph may be sent by the repair diagnostic apparatus to the user terminal after the object has been recognised. If a request for a further image from the user is made, the steps described herein above may be repeated for the new image data. Alternatively, different object recognition steps could be taken for the new image data when compared to the first image data.

As an example, the request for a further photograph may include a request for a subject of the image to be input. The subject may include, but is not limited to, the serial number of the faulty appliance, evidence of the fault (for example, leaking water), a warning light of the faulty appliance etc. An object recognition process may be carried out on the further photograph, which can be used to supplement the fault diagnostic report.

For example, if the request for a further photograph is a request for a photograph of a barcode or serial number of the object (e.g. the washing machine), this can be read (e.g. using OCR software for a serial number) and used to determine further information about the object.

In some of the above embodiments, the first image data is a photograph. However, embodiments of the invention are not limited to this. The first image data may be video data, and the object recognition processor may recognise the object by comparing information of the first image data (e.g. information from one or more frames of the video data) with information in the object datastore comprising information on a plurality of objects.

In some of the above embodiments, household appliances are provided as examples of suitable “objects” that could be at fault. However, it will be appreciated that the object could be any object that a user may wish to report a fault to a repair management system. The object could, for example, represent a stain on a wall or wallpaper that has come loose. More generally, the object could be any object and embodiments of the invention are not limited to diagnosing faults in household or domestic environments.

The apparatuses described above may be implemented on a single device or multiple devices in communication. More generally, it will be appreciated that the hardware used by embodiments of the invention can take a number of different forms. For example, all the components of embodiments of the invention could be provided by a single device, or different components of could be provided on separate devices. More generally, it will be appreciated that embodiments of the invention can provide a system that comprises one device or several devices in communication.

Although in the specific embodiment described above the internet is used, this is not essential to the present invention. The present invention can be applied to an application shared between machines that communicate with each other, for example, over a network. Therefore, although the specific embodiment network uses the Internet, the present invention is applicable to any network whether it be a conventional landline network or a wireless network. More specifically, the present invention is applicable to the Internet, an intranet, an extranet, a local area network, a wide area network or a network employing wireless application protocol.

Many further variations and modifications will suggest themselves to those versed in the art upon making reference to the foregoing illustrative embodiments, which are given by way of example only, and which are not intended to limit the scope of the invention, that being determined by the appended claims.

1. A computer-implemented repair diagnostic method comprising using a repair diagnostic apparatus to:
receive first image data representing an object with a fault that a user wishes to report;
recognize the object by comparing information of the first image data with information in an object datastore comprising information on a plurality of objects;
store information on the recognized object in a fault diagnostic report for managing the repair of the recognized object without text or voice communication about the fault between the user of the object and a user of the repair diagnostic apparatus; and
output repair information relating to repair of the recognized object to the user of the object, the repair information comprising information for providing augmented reality repair information to be overlaid on a user's handheld device, the augmented reality repair information being configured to aid the user to repair the recognized object.

2. The method according to claim 1, wherein the object datastore comprises a plurality of items of second image data, each item of second image data being associated with one of the plurality of objects;
wherein the comparing information of the first image data with information in the object datastore comprises:
performing a reverse image search to compare the first image data with the second image data to recognize the object.

3. The method according to claim 2, wherein after information on the recognized object is stored in the fault diagnostic report, the first image data of the recognized object is added to the object datastore as new second image data.

4. The method according to claim 1, wherein comparing information of the first image data with information in the object datastore comprises:
processing the received first image data to isolate feature elements of the object from within the first image data; and
comparing the isolated feature elements with information in the object datastore to recognize the object.

5. The method according to claim 1, wherein comparing information of the first image data with information in the object datastore comprises:
processing the received first image data to perform optical character recognition to identify text in the first image data; and
comparing the identified text with information in the object datastore to recognize the object.

6. The method according to claim 1, wherein recognizing the object comprises comparing information of the first image data with information in the object datastore to determine a best match for the object.

7. The method according to claim 6, further comprising:
providing the user with information on the determined best match for the object; and
receiving an indication from the user that indicates whether the determined best match corresponds to the object,
wherein if the indication from the user that indicates the determined best match corresponds to the object, the best match is determined as the recognized object.

8. The method according to claim 7, wherein if the indication from the user that indicates the determined best match does not correspond to the object, the method further comprises:
comparing information of the first image data with information in the object datastore to determine a next best match for the object; and
providing the user with information on the determined next best match.

9. The method according to claim 1, further comprising:
storing candidate faults associated with the plurality of objects in the object datastore; and
providing the user with information on at least one candidate fault associated with the recognized object.

10. The method according to claim 9, further comprising receiving a user message confirming that a said candidate fault is the fault associated with the object.

11. The method according to claim 9, further comprising diagnosing a most likely candidate fault based on the comparison of the information of the first image data with the information in the object datastore.

12. The method according to claim 1, wherein the first image data is received in a fault message comprising information regarding the user including at least one of: location of the user, identity of the user, language spoken by the user, and availability of the user for repair visits.

13. (canceled)

14. The method according to claim 1, further comprising using the repair diagnostic apparatus to:
output the fault report to a user of the repair management apparatus for managing the repair of recognized object.

15. The method according to claim 1, further comprising:
storing candidate faults associated with the plurality of objects in the object datastore; and
diagnosing a most likely candidate fault based on image processing of the first image.

16. A repair diagnostic apparatus comprising:
a communications mechanism arranged to receive first image data, the first image data representing an object with a fault that a user wishes to report;
an object recognition processor arranged to recognize the object by comparing information of the first image data with information in an object datastore comprising information on a plurality of objects; and
a fault processor arranged to store information on the recognized object in a fault diagnostic report for managing the repair of the recognized object,
wherein the communications mechanism is arranged to output repair information relating to repair of the recognized object to the user of the object, the repair information comprising information for providing augmented reality repair information to be overlaid on a user's handheld device, the augmented reality repair information being configured to aid the user to repair the recognized object.

17. The repair diagnostic apparatus according to claim 16, further comprising the object datastore.

18. The repair diagnostic apparatus according to claim 16, wherein the object datastore is stored on an external apparatus, and the object recognition processor is arranged to query the object datastore on the external apparatus.

19. A repair diagnostic system comprising:
a repair diagnostic apparatus according to claim 16; and
a user terminal comprising a camera for obtaining the first image data;
wherein the communications mechanism is arranged to receive the first image data from the user terminal.

20. A non-transitory computer readable medium carrying computer readable code for controlling a computer to carry out the method of claim 1.
